(19) United States
(12) Patent Application Publication
(10) Pub. No.: US 2026/0126561 A1
(43) Pub. Date: May 7, 2026

(54) PARAMETER-CONTROLLABLE LANDSLIDE TESTING APPARATUS

(71) Applicant: Tongji University, Shanghai (CN)

(72) Inventors: Ming PENG, Shanghai (CN); Yu RAO, Shanghai (CN); Zhenming SHI, Shanghai (CN); Yan ZHU, Shanghai (CN); Jianfeng CHEN, Shanghai (CN); Bo LI, Shanghai (CN); Qingxin ZHAO, Shanghai (CN); Zhi LI, Shanghai (CN)

(73) Assignee: Tongji University, Shanghai (CN)

(21) Appl. No.: 19/360,910

(22) Filed: Oct. 16, 2025

(30) Foreign Application Priority Data
Nov. 7, 2024 (CN) 202411579123.5

(51) Int. Cl. G01V 99/00

(52) U.S. Cl. CPC G01V 99/00

(57) ABSTRACT

A parameter-controllable landslide testing apparatus includes: a rail panel, a box body, a driving unit, a movable top plate and a morphology retention module. The box body is equipped with power wheels and a rolling base plate for loading a test object. The power wheels are positioned on a rail of the rail panel. The driving unit is mounted on the box body to actuate the power wheels, enabling the box body to move along the rail at a preset speed. The movable top plate is at a top of the box body. The morphology retention module is detachably fixed to the movable top plate and configured to maintain a contour morphology of the test object. Moreover, upon reaching a preset position on the rail, the movable top plate disengages the morphology retention module, allowing the test object to slide on the rolling base plate at the preset speed.

### CROSS-REFERENCE TO RELATED APPLICATIONS

This application claims priority to Chinese Patent Application No. 202411579123.5, filed on Nov. 7, 2024, the content of which is incorporated herein by reference in its entirety.

### TECHNICAL FIELD

This disclosure relates to the field of landslide simulating, and particularly to a parameter-controllable landslide testing apparatus.

### BACKGROUND

High-speed landslides at elevated positions are a type of natural disaster distinct from ordinary landslides, characterized by long travel distances, severe destructions, and complex disaster mechanisms. High-speed landslides often trigger chain reactions such as landslide-induced waves and river blockages. However, these landslides exhibit mechanical behaviors different from low-speed, short-distance and small-scale landslides, making them unsuitable for direct simulation using any conventional landslide testing apparatus. Current landslide tests primarily rely on gravity to accelerate sliding masses along fixed inclines, requiring a substantial acceleration distance to construct large-scale, long-distance test setups. This approach presents challenges including high construction difficulties, low spatial utilizations, and elevated costs for site or materials. Moreover, conventional tests using fixed inclines cannot preset a sliding velocity or a sliding angle, whereas actual high-speed landslides involve non-fixed sliding mass geometries. Additionally, the accelerating effect of gravity on the sliding structure is limited by sliding friction and air resistance, further compromising the accuracy of test results.

### SUMMARY

In view of the above, examples of the present disclosure provide a parameter-controllable landslide testing apparatus, which may partially address technical issues in conventional landslide testing, such as non-fixed sliding mass morphologies, low result accuracies, and high costs.

The parameter-controllable landslide testing apparatus according to some examples of the present disclosure may include: a rail panel, comprising a rail; a box body, equipped with a power wheel and a rolling base plate for loading a test object, wherein the power wheel is positioned on the rail; a driving unit, mounted on the box body to actuate the power wheel, enabling the box body to move along the rail at a preset speed; a movable top plate, installed at a top of the box body; a morphology retention module, detachably fixed to the movable top plate with one end and configured to maintain a contour morphology of the test object with the other end; where, upon reaching a preset position on the rail, the movable top plate may disengage the morphology retention module, allowing the test object to slide on the rolling base plate at the preset speed for a landslide testing.

As described above, the parameter-controllable landslide testing apparatus may utilize a motor-driven acceleration to overcome speed limitations of conventional landslide testing devices, significantly reducing a required size of an acceleration apparatus while enabling sliding masses to achieve a higher acceleration over a shorter distance. Through technical means such as a short-distance acceleration, an inclination control, and a morphology retention, the parameter-controllable landslide testing apparatus may achieve a high acceleration and a precise control of the sliding masses during landslide simulation tests. Compared to traditional landslide testing devices, not only a required spatial dimension may be reduced dramatically, but also the sliding masses may be tested under predetermined morphology and angle conditions. Thereby, the accuracy and reliability of the test may be improved.

### BRIEF DESCRIPTION OF THE DRAWINGS

To illustrate technical solutions of the present disclosure or the prior art more clearly, drawings used in examples or the prior art will be briefly introduced. Obviously, the drawings in the following description are only some examples of the present disclosure. For those of ordinary skill in the art, other drawings may be obtained based on these drawings without creative effort.

FIG. 1 illustrates a schematic diagram of the parameter-controllable landslide testing apparatus according to an example of the present disclosure.

FIG. 2 illustrates a schematic diagram of the parameter-controllable landslide testing apparatus according to another example of the present disclosure.

FIG. 3 illustrates a schematic diagram of the morphology retention unit according to an example of the present disclosure.

FIG. 4 illustrates a schematic diagram of the morphology retention module according to another example of the present disclosure.

FIG. 5 illustrates a schematic diagram of the movable top plate according to an example of the present disclosure.

FIG. 6 illustrates a schematic diagram of the top plate limiting unit according to an example of the present disclosure.

FIG. 7 illustrates a schematic diagram of a box body door according to an example of the present disclosure.

FIG. 8A illustrates a schematic diagram of a rotatable fixing member according to an example of the present disclosure.

FIG. 8B illustrates a schematic diagram of a rotatable fixing member according to another example of the present disclosure.

FIG. 9 illustrates a schematic diagram of an elastic telescopic member according to examples of the present disclosure.

FIG. 10 illustrates a schematic diagram of a linkage rod according to examples of the present disclosure.

FIG. 11 illustrates a schematic diagram demonstrating a working principle of the landslide testing apparatus according to an example of the present disclosure.

FIG. 12 illustrates a schematic diagram demonstrating a working principle of the landslide testing apparatus according to another example of the present disclosure.

FIG. 13 illustrates a schematic diagram demonstrating a working principle of the landslide testing apparatus according to still another example of the present disclosure.

FIG. 14 illustrates a schematic diagram of the rolling base plate according to examples of the present disclosure.

FIG. 15 illustrates a schematic diagram of a base plate according to examples of the present disclosure.

### DETAILED DESCRIPTION OF THE EMBODIMENTS

To make the objectives, technical solutions, and advantages of the present disclosure clearer, the following further describes the present disclosure in detail with reference to specific examples and accompanying drawings.

It should be noted that, unless otherwise defined, technical terms or scientific terms used in the examples of the present disclosure shall have the ordinary meanings understood by person skilled in the art. The terms “first,” “second,” and similar terms used in the examples of the present disclosure do not denote any order, quantity, or importance, but are merely used to distinguish different components. The terms “comprising” or “including” and similar terms mean that elements or items preceding the term encompass elements or items listed after the term and their equivalents, but do not exclude other elements or items. The terms “connected” or “coupled” and similar terms are not limited to physical or mechanical connections, but may include electrical connections, whether direct or indirect. Terms such as “upper,” “lower,” “left,” and “right” are used only to indicate relative positional relationships. When the absolute position of the described object changes, the relative positional relationship may also change accordingly.

In this document, it should be understood that the number of elements in the drawings is for illustration rather than limitation, and any naming is for differentiation only, without restrictive implications.

As stated above, current conventional landslide tests primarily rely on gravity to accelerate sliding masses on fixed slopes. This acceleration method requires significant acceleration distances for test specimens, imposing stringent dimensional requirements on the testing equipment. However, constructing a large-scale and long-distance conventional landslide testing apparatus presents multiple challenges, such as construction difficulties, low space utilizations and high costs for venues or materials. These factors make the actual manufacturing of such conventional landslide testing apparatus impractical during experimental processes. Moreover, regarding test velocities, gravity-accelerated landslide testing apparatus on fixed slopes cannot preset speed or inclination angles, and the acceleration effectiveness from gravity has an upper limit due to sliding frictions and air resistances. Additionally, a conventional landslide testing often overlook morphology retention during high-speed movements. Moreover, as actual high-speed landslides involve non-fixed deformations, it is necessary to test various possible sliding mass morphologies under extreme conditions to get accurate test results under different morphological conditions.

Existing high-speed debris flow simulation devices often utilize a natural sliding acceleration of soil along a fixed inclined slope. This landslide testing method has following limitations. First, a testing speed may be confined to a single value, test materials fail to form uniform thickness at slope terminus. Moreover, specific shapes or spatial volumes cannot be preserved. Single submarine landslide simulation devices differ from the high-speed debris flow simulation devices only by replacing air with water as the medium. Therefore, similar problems such as uncontrollable debris flow speeds and poor morphology retention capabilities may still exist. The fixed-angle soil natural acceleration landslide surge device may simulate landslide disasters and a subsequent surge disaster chain. However, while this device accounts for a certain volume of the water of sliding masses, it may suffer from uncontrollable entry speed and fixed cubic morphology, which significantly deviates from real sliding mass characteristics. A pneumatic feeding device was designed with track-mounted propulsion, which can achieve a short-distance acceleration of sliding masses to some extent. However, the maximum effective acceleration distance of the sliding mass for this device is only 1.235 m, and the pneumatic propulsion efficiency is still limited. It cannot simulate the sliding mass under extreme motion speeds. Additionally, this device cannot set the shape and dimension of the sliding mass, resulting in relatively single test conditions. It can be seen that most current soil model tests focusing on landslides generally fix the landslide angle and allow the sliding mass to fall naturally under gravity, thus resulting in the problem of fixed and uncontrollable velocities. Typically, when the sliding mass or debris flow material reaches the end of the slope, it is difficult for the test material to form a certain thickness. However, at the beginning of landslide surge and other disaster chains, large volumes of soil generally enter the water. Therefore, it is necessary for the test soil to have a certain shape or spatial volume. Consequently, how to accelerate the soil structure to the required motion state (speed, angle, and etc.) within a short time and a short distance, how to shape and fix the soil state according to experimental needs, and how to ensure that the sliding mass maintains a predetermined volume and target morphology when accelerated to the required motion state, have become urgent technical problems to be solved in order to improve the accuracy of the experiments.

In view of the above, the present disclosure provides a parameter-controllable landslide testing apparatus. The apparatus may include a box body equipped with a power wheel and a rolling base plate for loading a test object. The power wheel may be positioned on a rail and driven by a driving device mounted on the box body to ensure the box body moves along the rail at a preset speed. A movable top plate may also be installed on the top of the box body. Moreover, a morphology retention module may be provided with one end detachably fixed to the movable top plate and with the other end used to maintain a contour shape of the test object. When the box body moves to a preset position on the rail, the movable top plate may separate the morphology retention module from the movable top plate, allowing the test object to slide with the box body on the rolling base plate for landslide testing. The design of the parameter-controllable landslide testing apparatus utilizes a motor-driven acceleration to overcome the speed limitation of traditional landslide simulation devices, reducing a required size of the acceleration device significantly, enabling the sliding mass to achieve a higher acceleration within a shorter distance. Through a short-distance acceleration, an angle control, and a morphology retention, a high acceleration and a precise control of the sliding mass in the landslide testing can be achieved. Compared to traditional landslide simulation devices, it not only reduces the required spatial dimension substantially but also ensures the test object be conducted with predetermined shape and angle. In this way, the accuracy and the reliability of the test can be improved.

In examples of the present disclosure, the parameter-controllable landslide testing apparatus may include the following components: a rail panel, a box body, a driving unit, a movable top plate and a morphology retention module.

In examples of the present disclosure, the rail panel may include a rail. Specifically, the rail may be a dual-track rail. The box body may be equipped with a power wheel and a rolling base plate for loading a test object. Here, the power wheel may be positioned on the rail. The driving unit may be mounted on the box body to actuate the power wheel, enabling the box body to move along the rail at a preset speed. The movable top plate may be installed at a top of the box body. The morphology retention module may be detachably fixed to the movable top plate with one end and configured to maintain a contour morphology of the test object with the other end. Moreover, upon reaching a preset position on the rail, the movable top plate may disengage the morphology retention module, allowing the test object to slide on the rolling base plate at the preset speed for a landslide testing.

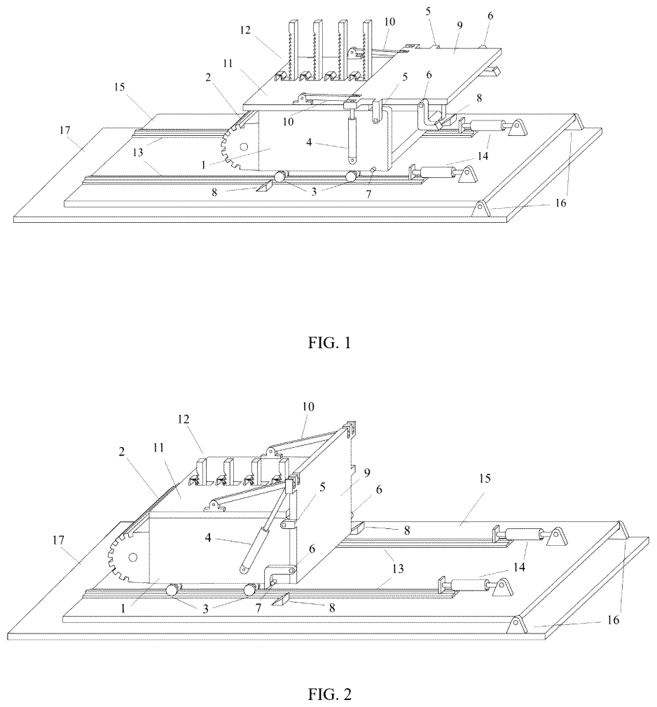

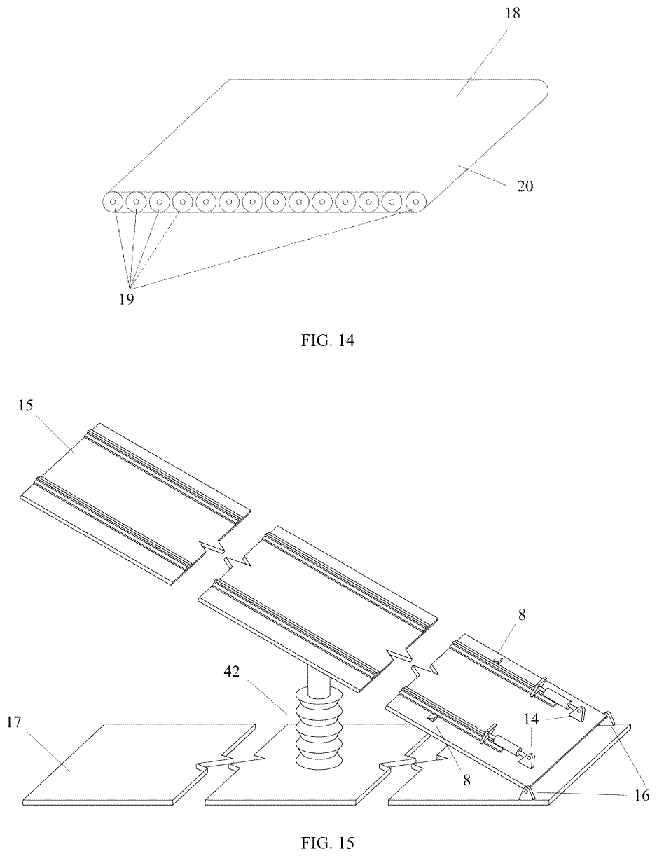

FIG. 1 and FIG. 2 illustrate schematic diagrams of the parameter-controllable landslide test apparatus according to examples of the present disclosure. In FIG. 1 and FIG. 2, the box body 1 may serve as a primary loading device for the test object. The diving device 2 (such as a driving motor) at a rear end of the box body 1 may be provided to control rolling speeds of the power wheels 3. An elastic telescopic member 4 (such as an elastic telescoping rod) may be provided to connect the box body 1 to a box door 9, allowing the box door 9 to rotate around a box-door connection member 5 (such as a box-door hinge) for opening/closing the box door 9 via the elastic telescopic member 4. After the closure of the box door 9, a rotatable fixing member 6 (such as an L-shaped lock 6) may lock the box door 9 to the box body 1 through a stopper 7. A rail panel limiter 8 may be fixed to a movable rail panel 15, with one of its slopes parallel to one of those of the rotatable fixing member 6. During a forward movement (toward the door) of the box body 1, contact between slopes of the rotatable fixing member 6 and the rail panel limiter 8 may cause the rotatable fixing member 6 to pivot upward around a hinge point 22, releasing its engagement with the stopper 7 and enabling the box door 9 open. Since the box door 9 is hinged to the movable top plate 11 via a linkage rod 10, the opening of the box door 9 simultaneously retracts the movable top plate 11, unlocking a top plate limiting device 12 and releasing the test object 37 (such as soil). The box body 1 then may move forward along the rail 13 under driving of the power wheels 3. Upon contact with a rail limiter 14 (such as an end damper) after the opening of the box door 9, the box body 1 may stop abruptly, allowing the test object 37 to move forward at a preset speed along the rolling base plate 18 (shown in FIG. 14). As shown in FIG. 14, the rolling base plate 18 may include a roller group 19 and a transmission belt 20, both may load the test object 37 stably and preserve its motion state maximally upon ejection.

In some examples of the present disclosure, the morphology retention module may include multiple morphology retention units; where, a morphology retention unit may include: a limiting plate, a main rod with a toothed portion and a first connecting member. Specifically, the limiting plate may be configured to define a contour shape of the test object. The main rod with the toothed portion may be configured to detachably secure the limiting plate to the movable top plate. The first connecting member may be configured to rotatably connect the limiting plate and the main rod. In some examples of the present disclosure, the angle between the limiting plate and the main rod may range from 0° to 180°.

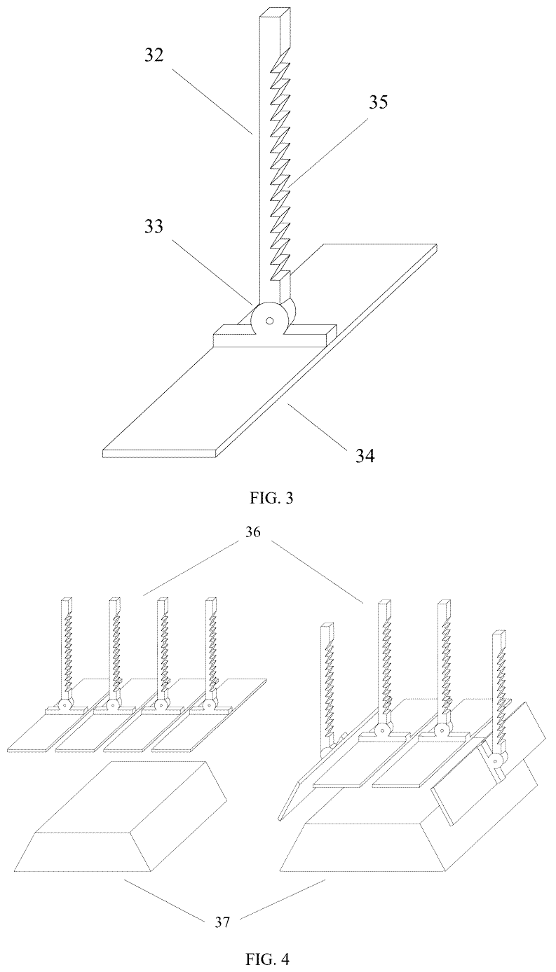

FIG. 3 illustrates a schematic diagram of a morphology retention unit according to an example of the present disclosure. FIG. 4 illustrates a schematic diagram of the morphology retention module according to an example of the present disclosure. In FIG. 3 and FIG. 4, the morphology retention unit may include the main rod 32, the limiting plate 34 and the first connecting member 33 (such as a hinge) between the main rod 32 and the limiting plate 34. The main rod 32 may constrain the test object 37 below it. The limiting plate 34 may rotate around the first connecting member 33. Further, multiple morphology retention units may be used to form the morphology retention module 36, enabling constraints on the test object 37 of a different shape and a different scale.

In some examples of the present disclosure, the movable top plate may include: through holes corresponding to the morphology retention module and a top plate limiting device. Where, the top plate limiting device may include multiple top plate limiting units. A top plate limiting unit may include: a top plate limiting module, an elastic member, a unidirectional restriction module and a second connecting member. Specifically, the top plate limiting module may be fixedly disposed on the movable top plate. The elastic member may be fixedly disposed on the top plate limiting module with one end. The unidirectional restriction module may be disposed on the other end of the elastic member, engaging with the toothed portion of the main rod passing through the through hole, to ensure a unidirectional downward movement of the main rod, thereby maintaining the limiting plate to limit the contour shape of the test object. The second connecting member may be configured to connect the unidirectional restriction module and the movable top plate. When the main rod moves downward, the unidirectional restriction module may rotate clockwise by a first angle from an initial position, and the elastic member and the top plate limiting module may cause the unidirectional restriction module to rebound back to the initial position.

In some examples of the present disclosure, the top plate limiting module may include: a first limiting portion and a second limiting portion set perpendicular to each other. Specifically, the first limiting portion may be disposed vertically on the movable top plate. The second limiting portion may be disposed parallel to the movable top plate. In some examples of the present disclosure, a cross-section of the first limiting portion may be of a shape of a trapezoid, with a lower side of the trapezoid positioned on the movable top plate. A cross-section of the second limiting portion may be rectangular. Moreover, a cross-section of the unidirectional restriction module may be triangular.

Moreover, the elastic member may be fixed at one end to a side of the first limiting portion adjacent to the toothed portion, and may be fixed at the other end to a first right-angle face of the unidirectional restriction module, such that the elastic member and the second limiting portion may be located on a same side of the first limiting portion.

Further, a second right-angle face of the unidirectional restriction module may be connected to the movable top plate via the second connecting member, and an inclined face of the unidirectional restriction module engages with the toothed portion.

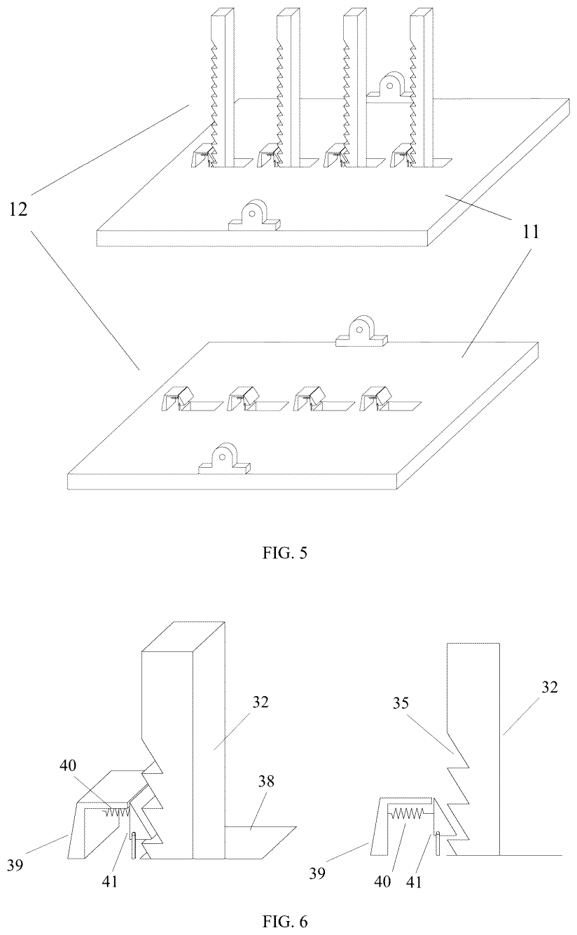

FIG. 5 illustrates a schematic diagram of the movable top plate according to an example of the present disclosure. FIG. 6 illustrates a schematic diagram of the top plate limiting unit according to an example of the present disclosure. In FIG. 5 and FIG. 6, the top plate limiting device 12 may include multiple top plate limiting units. Specifically, a top plate limiting unit may include: the top plate limiting module 39, the elastic member 40, the unidirectional restriction module 41 and a second connecting member. The presence of a main rod gear groove 35 may cause the unidirectional restriction module 41 to engage during the movement of the main rod 32 of the morphology retention unit. As the main rod 32 of the morphology retention unit moves downward, the unidirectional restriction module 41 may rotate clockwise. The elastic member 40 and the top plate limiting module 39 cooperate to ensure that the unidirectional restriction module 41 promptly rebounds after a small-angle rotation. The bottom of the unidirectional restriction module 41 engages with the horizontal plane of the main rod gear groove 35, restricting the unidirectional movement of the main rod 32 of the morphology retention unit.

In some examples of the present disclosure, the parameter-controllable landslide testing apparatus may further include a box door, rotatably disposed on the box body and connected to the movable top plate. Specifically, during a rotation, the box door may drive the movable top plate to move, causing the unidirectional restriction module to disengage from the toothed portion of the main rod to separate the limiting plate from the test object.

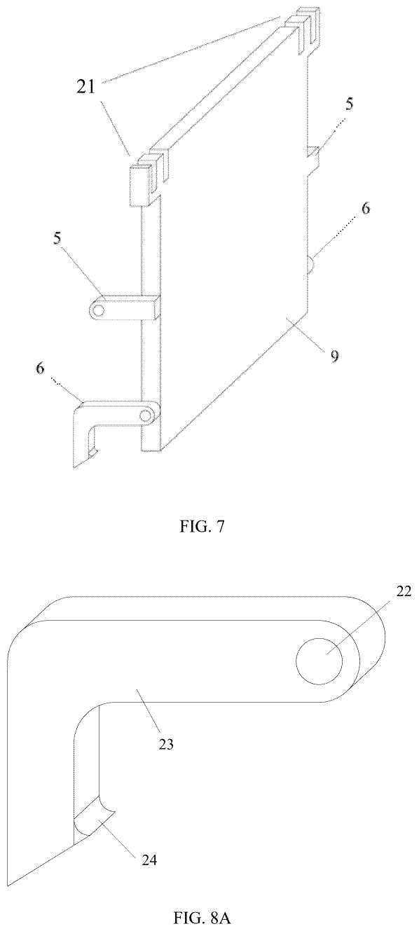

FIG. 7 illustrates a schematic diagram of a box body door according to an example of the present disclosure. In FIG. 7, the box door 9 may be provided with connection slots 21 at its top for connecting the elastic telescopic member 4 and the linkage rod 10. The elastic telescopic member 4, the linkage rod 10, and the box door 9 can all rotate around a hinge module of the connection slots 21. The rotatable fixing member 6 may include three main parts: a hinge point 22, an L-shaped latch body 23, and a latch tail elastic limiting module 24. The remaining structures can rotate around the hinge point 22. The latch tail elastic limiting module 24 may be made of elastic material, engages with the stopper 7 to achieve a structural interlocking.

In some examples of the present disclosure, the box door may include: a box door connecting member, configured to rotatably fix the box door to the box body; a rotatable fixing member, comprising: a first end portion rotatably fixed to the box door, a second end portion connected to the first end portion, wherein the second end portion has a first inclined surface; a first connection end, connected to a side of the box body via an elastic telescopic member; and a second connection end, connected to the movable top plate via a linkage rod.

In some examples of the present disclosure, the box body may further include: a stopper, disposed on the side of the box body and matched with the rotatable fixing member, configured to restrict rotations of the rotatable fixing member to fix the box door to the box body.

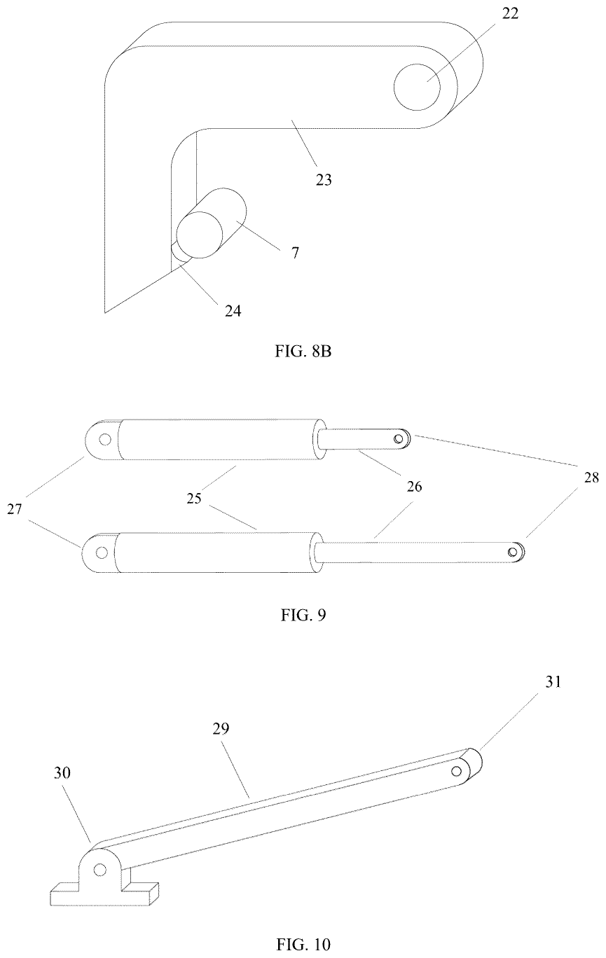

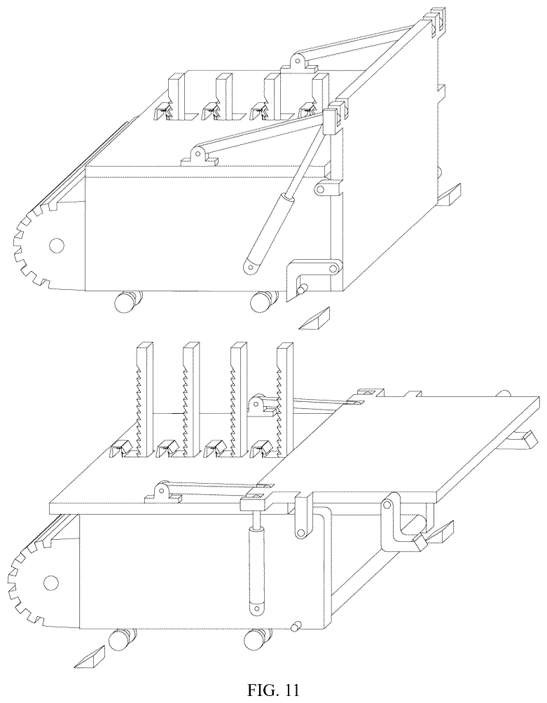

FIG. 8A and FIG. 8B illustrate schematic diagrams of the rotatable fixing member according to examples of the present disclosure. FIG. 9 illustrates a schematic diagram of an elastic telescopic member according to examples of the present disclosure. FIG. 10 illustrates a schematic diagram of a linkage rod according to examples of the present disclosure. The elastic telescopic member 4 may include a fixed segment 25 and a telescopic segment 26. The fixed segment 25 may be hinged to the side of the box body 1 via a fixed segment hinge end 27. Moreover, the telescopic segment 26 may be hinged to a connection slot 21. The linkage rod 10 may be a rigid structure composed of a rod main body 29, a rod-plate hinge end 30, and a rod-door hinge end 31. The rod-plate hinge end 30 may be positioned at the top of the box body 1, and the rod-door hinge end 31 may be hinged to a connection slot 21.

In some examples of the present disclosure, the parameter-controllable landslide testing apparatus may further include: a rail panel limiter, disposed on the rail panel and matched with the rotatable fixing member, having a second inclined surface; wherein, when the box body moves to the preset position on the rail, the second inclined surface of the rail panel limiter contacts the first inclined surface, and the second inclined surface drives the rotatable fixing member to rotate and separate from the stopper, causing the box door to rotate around the box door connecting member, thereby driving the linkage rod to move the movable top plate.

In some examples of the present disclosure, wherein an end of the rail is provided with a rail limiter; when the box body moves along the rail to the rail limiter, the box body stops moving, and the test object continues to move on the rolling base plate at the preset speed.

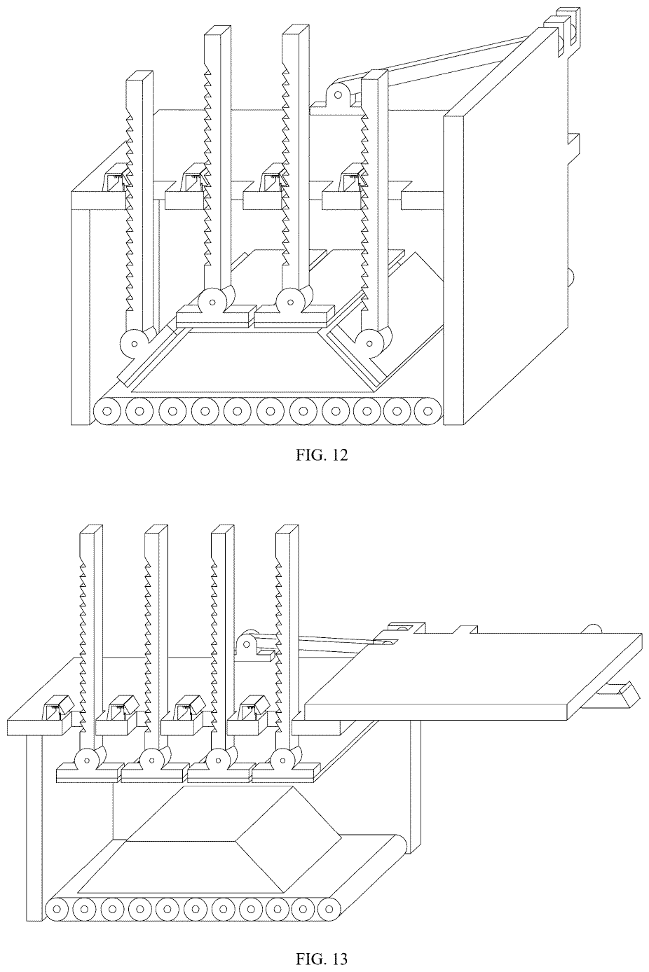

FIG. 11 to FIG. 13 illustrate schematic diagrams demonstrating a working principle of the landslide testing apparatus according to examples of the present disclosure. As shown in FIG. 11 to FIG. 13, during a forward movement of the box body 1 (a direction towards the box door), the rotatable fixing member 6 may come into a contact with the rail panel limiter 8. The contact may cause the rotatable fixing member 6 to pivot upward around the hinge point 22, thereby releasing the engagement between the rotatable fixing member 6 and the stopper 7. As a result, the box door 9 may open. Since the box door 9 is hinged to the movable top plate 11 via the linkage rod 10, the movable top plate 11 may be pushed backward simultaneously as the box door 9 opens. Therefore, the top plate limiting device 12 may be unlocked and constraints on the test object 37 may be released. Under the traction of the power wheels 3, the box body may move forward along the rail 13. After the box door 9 opens, the box body 1 may reach the rail limiter 14 quickly. In this case, though the box body 1 stops moving, the test object 37 may still move forward at a preset speed along the rolling base plate 18 of the box body 1.

FIG. 14 illustrates a schematic diagram of the rolling base plate according to examples of the present disclosure. As shown in FIG. 14, the rolling base plate 18 may include a roller group 19 and a transmission belt 20.

It can be seen that, the landslide testing apparatus of the present disclosure can simulate high-speed sliding masses, so the test object (e.g., soil) may move at a relatively high speed, allowing it to continue moving forward by inertia. A separation between the test object and the box body may be implemented by a velocity difference between the decelerated model box and the test object moving forward by inertia. Further, the rolling base plate 18 may facilitate a smoother separation by the roller group 19 and the transmission belt 20, which may be regarded as an outer track structure of the roller group 19.

In some examples of the present disclosure, the parameter-controllable landslide testing apparatus may further include: an apparatus base plate, disposed below the rail panel; and an angle adjuster, disposed between the apparatus base plate and the rail panel, configured to adjust the angle of the apparatus base plate.

FIG. 15 illustrates a schematic diagram of a base plate according to examples of the present disclosure. As shown in FIG. 15, during a test, an angle of the movable track panel 15 can be adjusted via the angle adjuster 16 (such as a base plate hinge) to control the movement angle of the test object 37. The angle of the movable track panel 15 may be set to any desired angle as required. The apparatus base plate 17 may be rigidly connected to the ground to ensure an overall stability of the apparatus during testing. It should be noted that the length of the rail can be designed according to requirements, and the inclination angle of the rail can be adjusted using a hydraulic cylinder 42 as needed for the test.

It can be seen that the landslide test apparatus according to the present disclosure further proposes technologies or methods such as a short-distance acceleration, an inclination angle control, and a morphology maintenance based on traditional landslide simulation devices. By adopting a motor-driven acceleration, this apparatus may overcome the speed limitation of sliding masses in conventional landslide simulation, significantly reduces the required dimension of landslide acceleration devices, and achieves the goal of providing a higher acceleration to sliding masses. Simultaneously, it combines sliding morphology maintenance devices and sliding groove inclination control devices to ensure that the sliding structure can undergo required tests with predetermined shapes and angles. Furthermore, as a starting device for high-speed and high-position landslide disaster simulation experiments, this landslide testing apparatus can also be further used to simulate disaster chains such as landslide surges, landslide river blockages, and impacts on highway and bridge models, providing a strong technical support for landslide disaster research and prevention.

It should be noted that the present disclosure allows for the structural quantity and scale of each structural component to be designed according to actual experimental requirements. Examples include using larger model box dimensions, adopting more soil morphology fixation modules, employing three-dimensional soil module fixation schemes, modifying test track angles or dimensions, using curved fixed baffles, operating in underwater or vacuum environments, or utilizing the above apparatus as disaster chain triggering conditions. Any modifications made to the present disclosure that are non-essential in nature while still employing the technical solutions proposed herein shall fall within the scope of the present disclosure.

It should be noted that the above description only provides examples of the present disclosure. In some cases, actions or steps described in the examples may be executed in a different order than that described above while still achieving the desired results. Additionally, processes depicted in the drawings do not necessarily require the specific or sequential order shown to achieve the desired results. In certain implementations, multitasking and parallel processing may also be permissible or advantageous.

For ordinary skilled person in the relevant field, it should be understood that the discussion of any examples herein is merely exemplary and not intended to imply that the scope of the present disclosure (including claims) is limited to these examples. Under the framework of the present disclosure, technical features between different examples or within the same example may be combined, steps may be implemented in any order, and there exist many other variations of the aspects of the present disclosure examples as described above, which are not provided in detail for brevity.

Furthermore, to simplify explanation and discussion and to avoid making the examples of the present disclosure difficult to understand, well-known power/ground connections of integrated circuit (IC) chips and other components may or may not be shown in the provided drawings. Additionally, devices may be depicted in block diagrams to avoid making the examples of the present disclosure difficult to understand, taking into account the fact that implementation details of these block diagram devices are highly platform-dependent (i.e., these details should be fully within the comprehension of ordinary skilled person in the field). When specific details (e.g., circuits) are provided to describe examples of the present disclosure, it is obvious to ordinary skilled person that the examples of the present disclosure may be implemented without these specific details or with variations thereof. Therefore, such descriptions should be regarded as illustrative rather than restrictive.

Although this application has been described in conjunction with specific examples of the present disclosure, many alternatives, modifications, and variations of these examples will be apparent to those of ordinary skill in the art based on the foregoing description. For example, other memory architectures (e.g., dynamic RAM (DRAM)) may use the discussed examples.

Examples of the present disclosure are intended to cover all such alternatives, modifications, and variations that fall within the broad scope of the claims of this application. Therefore, any omissions, modifications, equivalent substitutions, improvements, etc., made within the spirit and principles of examples of the present disclosure should be included within the protection scope of this application.

What is claimed is:

1. A parameter-controllable landslide testing apparatus, comprising:
a rail panel, comprising a rail;
a box body, equipped with a power wheel and a rolling base plate for loading a test object;
wherein, the power wheel is positioned on the rail;
a driving unit, mounted on the box body to actuate the power wheel, enabling the box body to move along the rail at a preset speed;
a movable top plate, installed at a top of the box body; and
a morphology retention module, detachably fixed to the movable top plate with one end and configured to maintain a contour morphology of the test object with the other end; wherein,
upon reaching a preset position on the rail, the movable top plate disengages the morphology retention module, allowing the test object to slide on the rolling base plate at the preset speed for a landslide testing.

2. The parameter-controllable landslide testing apparatus according to claim 1, wherein, the morphology retention module comprises:
a limiting plate, configured to define a contour shape of the test object;
a main rod with a toothed portion, configured to detachably secure the limiting plate to the movable top plate; and
a first connecting member, configured to rotatably connect the limiting plate and the main rod;
wherein, the angle between the limiting plate and the main rod ranges from 0°to 180°.

3. The parameter-controllable landslide testing apparatus according to claim 2, wherein, the movable top plate comprises: a through hole corresponding to the morphology retention module and a top plate limiting device; wherein,
the top plate limiting device comprises:
a top plate limiting module, fixedly disposed on the movable top plate;
an elastic member, with one end fixedly disposed on the top plate limiting module;
a unidirectional restriction module, disposed on the other end of the elastic member, engaging with a toothed portion of the main rod passing through the through hole, to ensure a unidirectional downward movement of the main rod, thereby maintaining the limiting plate to limit the contour shape of the test object; and
a second connecting member, configured to connect the unidirectional restriction module and the movable top plate; wherein,
when the main rod moves downward, the unidirectional restriction module rotates clockwise by a first angle from an initial position, and the elastic member and the top plate limiting module cause the unidirectional restriction module to rebound back to the initial position.

4. The parameter-controllable landslide testing apparatus according to claim 3, wherein, the top plate limiting module comprises:
a first limiting portion and a second limiting portion set perpendicular to each other, wherein,
the first limiting portion is disposed vertically on the movable top plate;
the second limiting portion is disposed parallel to the movable top plate;
a cross-section of the first limiting portion is of a shape of a trapezoid, with a lower side of the trapezoid positioned on the movable top plate;
a cross-section of the second limiting portion is rectangular;
a cross-section of the unidirectional restriction module is triangular;
the elastic member is fixed at one end to the side of the first limiting portion adjacent to the toothed portion, and fixed at the other end to a first right-angle face of the unidirectional restriction module, such that the elastic member and the second limiting portion are located on a same side of the first limiting portion; and
a second right-angle face of the unidirectional restriction module is connected to the movable top plate via the second connecting member, and an inclined face of the unidirectional restriction module engages with the toothed portion.

5. The parameter-controllable landslide testing apparatus according to claim 4, further comprising:
a box door, rotatably disposed on the box body and connected to the movable top plate; wherein,
during a rotation, the box door drives the movable top plate to move, causing the unidirectional restriction module to disengage from the toothed portion of the main rod to separate the limiting plate from the test object.

6. The parameter-controllable landslide testing apparatus according to claim 5, wherein the box door comprises:
a box-door connection member, configured to rotatably fix the box door to the box body;
a rotatable fixing member, comprising: a first end portion rotatably fixed to the box door, a second end portion connected to the first end portion, wherein the second end portion has a first inclined surface;
a first connection end, connected to a side of the box body via an elastic telescopic member; and
a second connection end, connected to the movable top plate via a linkage rod.

7. The parameter-controllable landslide testing apparatus according to claim 6, wherein the box body further comprises:
a stopper, disposed on the side of the box body and matched with the rotatable fixing member, configured to restrict rotations of the rotatable fixing member to fix the box door to the box body.

8. The parameter-controllable landslide testing apparatus according to claim 7, further comprising:
a rail panel limiter, disposed on the rail panel and matched with the rotatable fixing member, having a second inclined surface; wherein, when the box body moves to the preset position on the rail, the second inclined surface of the rail panel limiter contacts the first inclined surface, and the second inclined surface drives the rotatable fixing member to rotate and separate from the stopper, causing the box door to rotate around the box door connecting member, thereby driving the linkage rod to move the movable top plate.

9. The parameter-controllable landslide testing apparatus according to claim 1, wherein an end of the rail is provided with a rail limiter; when the box body moves along the rail to the rail limiter, the box body stops moving, and the test object continues to move on the rolling base plate at the preset speed.

10. The parameter-controllable landslide testing apparatus according to claim 1, further comprising:
an apparatus base plate, disposed below the rail panel; and
an angle adjuster, disposed between the apparatus base plate and the rail panel, configured to adjust the angle of the apparatus base plate.
